(19) United States
(12) Patent Application Publication
(10) Pub. No.: US 2014/0328531 A1
(43) Pub. Date: Nov. 6, 2014

(54) MEDICAL IMAGING APPARATUS AND METHOD OF CONTROLLING THE SAME

(71) Applicants: SAMSUNG ELECTRONICS CO., LTD., Suwon-si (KR); SAMSUNG LIFE PUBLIC WELFARE FOUNDATION, Seoul (KR)

(72) Inventors: Jae Hak LEE, Yongin-si (KR); Young Hun SUNG, Hwaseong-si (KR); Ho Young LEE, Suwon-si (KR); Myung Jin CHUNG, Seoul (KR)

(73) Assignees: SAMSUNG LIFE PUBLIC WELFARE FOUNDATION, Seoul (KR); SAMSUNG ELECTRONICS CO., LTD., Suwon-si (KR)

(21) Appl. No.: 14/269,269

(22) Filed: May 5, 2014

(30) Foreign Application Priority Data
May 3, 2013 (KR) 10-2013-0049953

(51) Int. Cl. G06K 9/00; G06T 7/00

(52) U.S. Cl. CPC G06K 9/00201; G06T 7/0012
USPC 382/131

(57) ABSTRACT

A medical imaging apparatus includes: a scanner configured to obtain projection data of an object; a three-dimensional restorer configured to restore a volume of the object from the projection data; a volume segmentor configured to generate at least one partial volume based on the volume of the object; a reprojector configured to generate a plurality of reprojection images according to a plurality of virtual viewpoints by reprojecting at least one from among the volume and the at least one partial volume from the plurality of virtual viewpoints; and an image fuser configured to generate a plurality of fusion images by fusing at least two of the plurality of reprojection images according to the virtual viewpoints.

### CROSS-REFERENCE TO RELATED APPLICATION

This application claims priority from Korean Patent Application No. 10-2013-0040053, filed on May 3, 2013 in the Korean Intellectual Property Office, the disclosure of which is incorporated herein by reference in its entirety.

### BACKGROUND

1. Field

Apparatuses and methods consistent with exemplary embodiments relate to a medical imaging apparatus that images an inside of an object in a three-dimensional manner and a method of controlling the same.

2. Description of the Related Art

Medical imaging apparatuses such as computed tomography (CT) apparatuses, positron emission tomography (PET) apparatuses, tomosynthesis apparatuses, and magnetic resonance imaging (MRI) apparatuses radiate radioactive rays onto an object or apply a magnetic field to the object, thereby imaging an inside of the object in a non-invasive manner.

In particular, the medical imaging apparatuses may generate three-dimensional volume data together with a two-dimensional cross-sectional image of the object. The three-dimensional volume data may allow a user to check a morphological characteristic of the inside of the object and thus may be useful in a diagnosis field.

In general, the volume data of the object is displayed as a two-dimensional image from one viewpoint through volume rendering or is displayed as a two-dimensional image of a particular slice. Thus, it may be difficult to check an internal structure of the object or a degree at which materials inside the object overlap each other in a depth direction.

### SUMMARY

One or more exemplary embodiments provide a medical imaging apparatus that may improve a contrast and a three-dimensional effect of an image by partially segmenting an entire volume of an object restored in a three-dimensional manner, by reprojecting the segmented partial volume and the entire volume from a plurality of viewpoints, by fusing the reprojected partial volume and entire volume, and by displaying the fused volumes on a three-dimensional display device, and a method of controlling the medical imaging apparatus.

One or more exemplary embodiments also provide a medical imaging apparatus that may improve user selectivity by displaying reprojection images of an entire volume of the object, or by fusing and displaying reprojection images of the entire volume and a partial volume of the object, or by displaying reprojection images of the partial volume, or by fusing and displaying the reprojection images of the partial volume according to a user's selection, and a method of controlling the medical imaging apparatus.

In accordance with an aspect of an exemplary embodiment, there is provided a medical imaging apparatus including: a scanner configured to obtain projection data of an object; a three-dimensional restorer configured to restore a volume of the object based on the projection data; a volume segmentor that generates at least one partial volume based on the volume of the object; a reprojector configured to generate a plurality of reprojection images according to a plurality of virtual viewpoints by reprojecting at least one from among the volume and the at least one partial volume from the plurality of virtual viewpoints; and an image fuser configured to generate a plurality of fusion images by fusing at least two of the plurality of reprojection images according to the plurality of virtual viewpoints.

The scanner may obtain the projection data from a plurality of viewpoints.

The three-dimensional restorer may include a cross-sectional image generator configured to generate a plurality of two-dimensional cross-sectional images of the object based on the projection data; and a volume data generator configured to generate volume data of the object based on the plurality of two-dimensional cross-sectional images.

The medical imaging apparatus may further include an inputter configured to receive selection of a part to be segmented from the volume, and the volume segmentor may segment the selected part from the volume.

The inputter may receive selection of the at least two of the plurality of reprojection images to be fused, and the image fuser may fuse the selected at least two of the plurality of reprojection images.

The medical imaging apparatus may further include a display device configured to display the plurality of fusion images according to the plurality of virtual viewpoints in a three-dimensional manner.

The inputter may receive selection from among the plurality of reprojection images and the plurality of fusion images to be displayed on the display device in the three-dimensional manner, and the display device may display selected images in the three-dimensional manner.

The display device may include a display configured to display the plurality of fusion images according to the plurality of virtual viewpoints in the three-dimensional manner, and a display controller configured to control the display.

The display controller may control the display to substantially simultaneously or alternately display the plurality of fusion images according to the plurality of virtual viewpoints.

The display controller may control to weave the plurality of fusion images according to the plurality of virtual viewpoints and control the display to display the weaved plurality of fusion images according to the plurality of virtual viewpoints.

The scanner may obtain the projection data of the object by performing at least one from among computed tomography (CT), positron emission tomography, tomosynthesis, and magnetic resonance imaging.

The image fuser may fuse the plurality of reprojection images by using at least one from among average, weighted average, edge preserving fusion, and maximum selection.

In accordance with an aspect of another exemplary embodiment, there is provided a method of controlling a medical imaging apparatus including: obtaining projection data of an object; restoring a volume of the object based on the projection data; generating at least one partial volume based on the volume of the object; generating a plurality of reprojection images by reprojecting at least one from among the volume and the at least one partial volume from a plurality of virtual viewpoints; and generating a plurality of fusion images by fusing at least two of the plurality of reprojection images according to the virtual viewpoints.

In accordance with an aspect of still another exemplary embodiment, there is provided a method of controlling a medical imaging apparatus including: determining a first volume and a second volume of an object based on a plurality of scanned images of the object; generating a plurality of first volume reprojection images by reprojecting the first volume of the object from a plurality of virtual viewpoints; generating a plurality of second reprojection images by reprojecting the second volume of the object from the plurality of virtual viewpoints; and providing a three dimensional image of the object based on the plurality of first reprojection images and the plurality of second reprojection images.

The providing may include providing the three dimensional image of the object based on fusion images generated by fusing the plurality of first reprojection images and the plurality of second reprojection images according to the plurality of virtual viewpoints.

### BRIEF DESCRIPTION OF THE DRAWINGS

The above and/or other aspects will become apparent and more readily appreciated from the following description of exemplary embodiments, taken in conjunction with the accompanying drawings in which:

FIG. 1 is a control block diagram of a medical imaging apparatus in accordance with an exemplary embodiment;

FIG. 2A illustrates an exterior of a scanner that performs computed tomography (CT) imaging in accordance with an exemplary embodiment;

FIG. 2B is a cross-sectional view of a radioactive ray source that radiates X-rays in accordance with an exemplary embodiment;

FIGS. 3A and 3B illustrate an exterior of the scanner that performs tomosynthesis in accordance with an exemplary embodiment;

FIG. 3C illustrates a structure of a radioactive ray detector that detects X-rays in accordance with an exemplary embodiment;

FIG. 4 illustrates an exterior of the scanner that uses magnetic resonance in accordance with an exemplary embodiment;

FIG. 5 is a detailed control block diagram of a medical imaging apparatus in accordance with an exemplary embodiment;

FIG. 6A schematically illustrates a cross-sectional image of an object in accordance with an exemplary embodiment;

FIG. 6B schematically illustrates a volume of a restored object in accordance with an exemplary embodiment;

FIGS. 7A and 7B schematically illustrate a partial volume or partial volumes segmented from an entire volume of the object in accordance with exemplary embodiments;

FIGS. 8A through 8C schematically illustrate an operation of reprojecting an entire volume or partial volume(s) from a right viewpoint and a left viewpoint in accordance with exemplary embodiments;

FIG. 9 schematically illustrates an operation of reprojecting an entire volume or a partial volume from a plurality of viewpoints; in accordance with an exemplary embodiment

FIGS. 10A through 10C schematically illustrate an operation of fusing reprojection images from a right viewpoint and a left viewpoint in accordance with exemplary embodiments;

FIG. 11 schematically illustrates an operation of fusing images reprojected from a plurality of viewpoints in accordance with an exemplary embodiment;

FIG. 12 is a control block diagram of a medical imaging apparatus that further includes a host device in accordance with another exemplary embodiment;

FIGS. 13A through 13D illustrate an exterior of a medical imaging apparatus in accordance with another exemplary embodiments;

FIG. 14 is a flowchart illustrating a method of controlling a medical imaging apparatus in accordance with an exemplary embodiment;

FIG. 15 is a flowchart illustrating a method of controlling a medical imaging apparatus in accordance with another exemplary embodiment;

FIG. 16 is a flowchart illustrating a method of controlling a medical imaging apparatus in accordance with another exemplary embodiment; and

FIG. 17 is a flowchart illustrating a method of controlling a medical imaging apparatus in accordance with another exemplary embodiment.

### DETAILED DESCRIPTION

Certain exemplary embodiments will now be described in detail with reference to the accompanying drawings, wherein like reference numerals refer to like elements throughout.

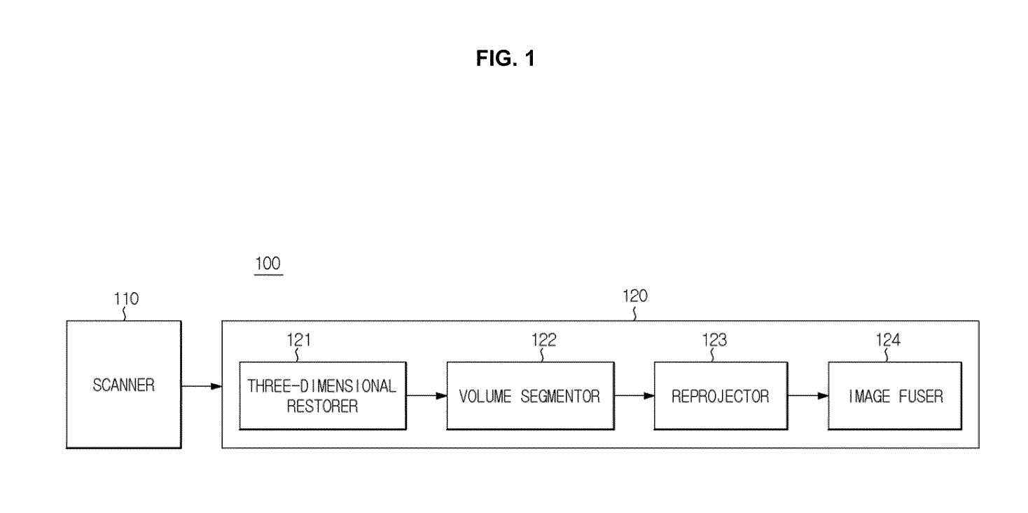

FIG. 1 is a control block diagram of a medical imaging apparatus in accordance with an exemplary embodiment.

Referring to FIG. 1, a medical imaging apparatus 100 in accordance with an exemplary embodiment includes a scanner 110 that obtains projection data regarding an inside of an object by scanning the object and an image controller 120 that restores a volume of the object using the projection data and generates a three-dimensional image regarding the object from the volume of the object.

In an exemplary embodiment, the object is a part of a subject to be inspected for diagnosis using the medical imaging apparatus 100. For example, when the part to be inspected is a chest, the chest is the object, and when the part to be inspected is a breast, the breast is the object. The subject may be a body including the human body, and any subject having an internal structure that may be imaged by the medical imaging apparatus 100 may be the subject of the medical imaging apparatus 100.

The image controller 120 includes a three-dimensional restorer 121 that restores the volume of the object from the projection data regarding the object in a three-dimensional manner, a volume segmentor 122 that generates a partial volume or partial volumes by partially segmenting the entire volume of the object, a reprojector 123 that generates reprojection images by reprojecting the entire volume and the partial volume(s) from a plurality of virtual viewpoints, and an image fuser 124 that generates fusion images by fusing the reprojection images regarding two or more volumes of the entire volume and at least one partial volume according to the virtual viewpoints.

The image controller 120 may include one or more hardware and/or software components. For example, the image controller 120 may include one or more of an integrated circuitry, a dedicated circuit, firmware, and/or a processor such as a central processing unit (CPU) which executes software programs stored in a storage, e.g., a memory.

Projection data regarding the object is obtained to image the inside of the object. As described above, the scanner 110 obtains the projection data regarding the object by scanning the object. Thus, the scanner 110 may use radioactive rays or magnetic resonance to image the inside of the object. Also, the scanner 110 scans the object from a plurality of different viewpoints to image the inside of the object in the three-dimensional manner.

In detail, the scanner 110 may perform at least one from among computed tomography (CT), positron emission tomography (PET), and tomosynthesis using radioactive rays, or magnetic resonance imaging. Alternatively, the scanner 110 may perform a combination of two or more of the above-described imaging methods. Hereinafter, in each case, a configuration and an operation of the scanner 110 will be described.

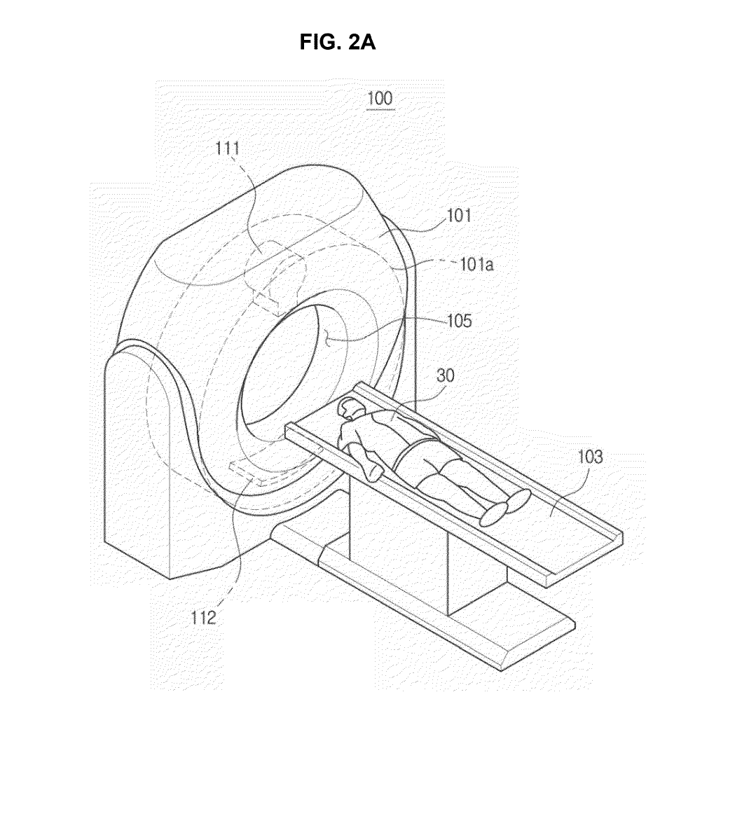

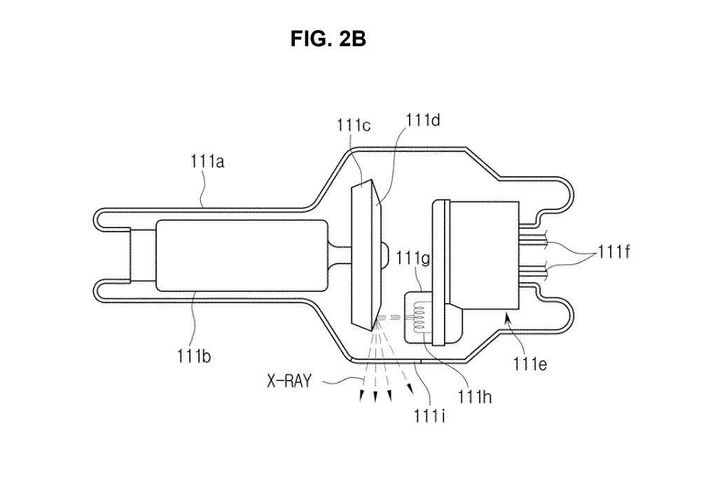

FIG. 2A illustrates an exterior of a scanner that performs CT imaging in accordance with an exemplary embodiment, and FIG. 2B is a cross-sectional view of a radioactive ray source that radiates X-rays in accordance with an exemplary embodiment.

When the scanner 110 performs CT imaging, the scanner 110 includes a radioactive ray source 111 that radiates radioactive rays onto an object 30 and a radioactive ray detector module 112 that detects the radioactive rays transmitted through the object 30, as illustrated in FIG. 2A. The radioactive ray source 111 and the radioactive ray detector module 112 are mounted on a gantry 101a, and the gantry 101a is mounted in a housing 101. The radioactive ray source 111 and the radioactive ray detector module 112 may be arranged to face each other.

When a patient table 103 on which the object 30 is placed is transported into a bore 105, the gantry 101a on which the radioactive ray source 111 and the radioactive ray detector module 112 are mounted, rotates about a periphery of the bore 105 at, for example, about 360°. Accordingly, the object 30 is scanned, and projection data is obtained.

The radioactive rays include X-rays, gamma rays, alpha rays, beta rays, and neutron rays. Thus, when the scanner 110 performs CT imaging, the radioactive ray source 111 may radiate X-rays.

When the radioactive ray source 111 radiates X-rays, as illustrated in FIG. 2B, the X-ray source 111 may be implemented with a two-pole vacuum tube including an anode 111c and a cathode 111e. The cathode 111e includes a filament 111h and a focusing electrode 111g that focuses electrons. The focusing electrode 111g is also referred to as a focusing cup.

The inside of a glass bulb 111a is in a higher vacuum state of about 10 mmHg, and the cathode filament 111h is heated to a higher temperature, thereby generating thermoelectrons. As an example of the filament 111h, a tungsten (W) filament may be used, and the filament 111h may be heated by applying a current to an electrical conducting wire 111f connected to the filament 111h.

The anode 111c may mainly include copper (Cu), and a target material 111d may be applied or disposed at a side facing the cathode 111e. Here, the target material 111d may be a higher resistance material, such as chromium (Cr), iron (Fe), cobalt (Co), nickel (Ni), tungsten (W), and molybdenum (Mo). The higher the melting point of the target material 111d is, the smaller a focal spot size may be. Here, the focal spot means an effective focal spot. Also, the target material 111d may be inclined at a predetermined angle relative to the cathode 111e. Thus, the smaller the inclined angle is, the smaller the focal spot size may be.

When a higher voltage is applied between the cathode 111e and the anode 111c, the thermoelectrons generated in the filament 111h are accelerated, collide with the target material 111d of the anode 111c, and thus generate X-rays. The generated X-rays may be radiated to the outside through a window 111i. In this case, the window 111i may include a beryllium (Be) thin film. In this case, a filter may be placed at a front or rear side of the window 111i to filter X-rays in a particular energy band.

The target material 111d may be rotated by a rotor 111b. When the target material 111d is rotated, thermal accumulation may be increased by about 10 times or more per unit area, and the focal spot size may be reduced compared to the case in which the target material 111d is fixed.

A voltage applied between the cathode 111e and the anode 111c of the X-ray source 111 is referred to as a tube voltage, and the magnitude of the tube voltage may be indicated by a peak value kVp. When the tube voltage increases, emission acceleration of the thermoelectrons increases. As a result, the energy (or photon energy) of the X-rays generated while colliding with the target material 111d may be increased. A current that flows through the X-ray source 111 is referred to as a tube current. The tube current may be indicated by an average value (mA). When the tube current increases, the number of the thermoelectrons emitted from the filament 111h increases, and as a result, a radiation dose (i.e., the number of X-ray photons) of the X-rays generated while colliding with the target material 111d increases.

Thus, energy levels of the X-rays may be adjusted by adjusting the tube voltage, and strengths and radiation doses of the X-rays may be adjusted by adjusting the tube current and X-ray exposure time. Thus, the energy levels or strengths of the radiated X-rays may be adjusted according to a type or characteristics of the object 30.

When the radiated X-rays have a predetermined energy band, the energy band may be defined by an upper limit and a lower limit. The upper limit of the energy band, i.e., a maximum energy of the radiated X-rays may be adjusted by the magnitude of the tube voltage, and the lower limit of the energy band, i.e., a minimum energy of the radiated X-rays may be adjusted by the filter. When X-rays in a lower energy band are filtered using the filter, the average energy of the radiated X-rays may be increased.

The radioactive ray detector module 112 obtains the projection data regarding the object 30 by detecting X-rays transmitted by the object 30 and transmits the obtained projection data to the image controller 120.

The radioactive ray detector module 112 in CT imaging is also referred to as a data acquisition system (DAS). Thus, the radioactive ray detector module 112 may include a plurality of detectors mounted in a one-dimensional array on a frame. Detailed descriptions of the structure of the radioactive ray detector module 112 will be described below.

When the scanner 110 performs positron emission tomography, medicines obtained by combining radioactive isotopes that emit positrons are injected into the body and then are traced using the scanner 110, thereby checking distribution of the medicines in the body. Even in this case, an exterior of the scanner 110 may be similar to that in the case where CT imaging illustrated in FIG. 2A is performed.

The emitted positrons are combined with peripheral electrons in the body and become extinct. When the positrons become extinct, gamma rays are emitted in two directions. The two gamma rays are emitted in opposite directions and are transmitted by a body tissue. Thus, the scanner 110 includes a radioactive ray detector module that detects gamma rays transmitted by the body tissue. Since a direction in which the gamma rays are to be emitted is not predictable, the radioactive ray detector module has a shape in which a plurality of detectors are arranged in a circular ring form that surrounds the object 30.

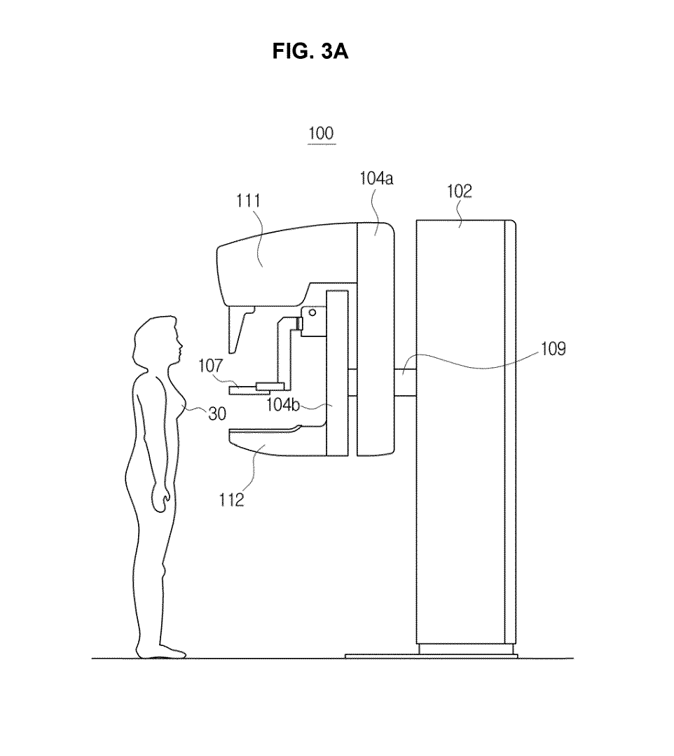

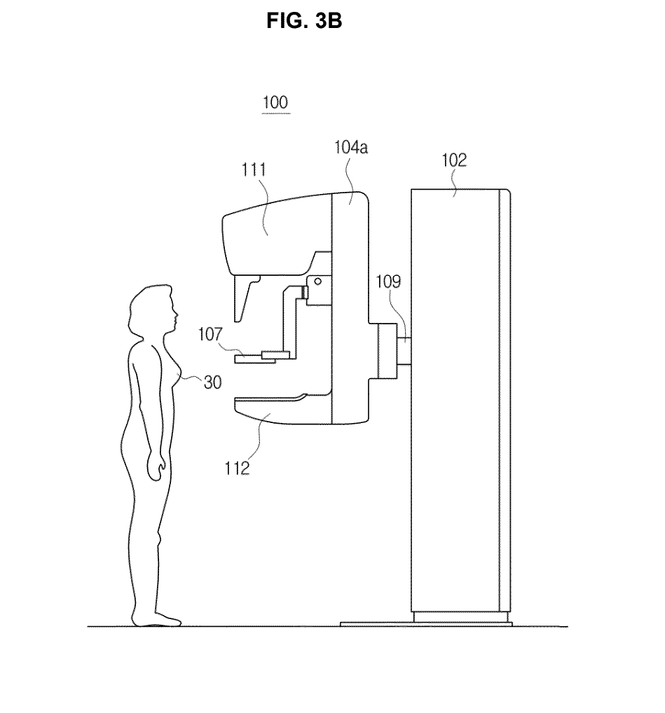

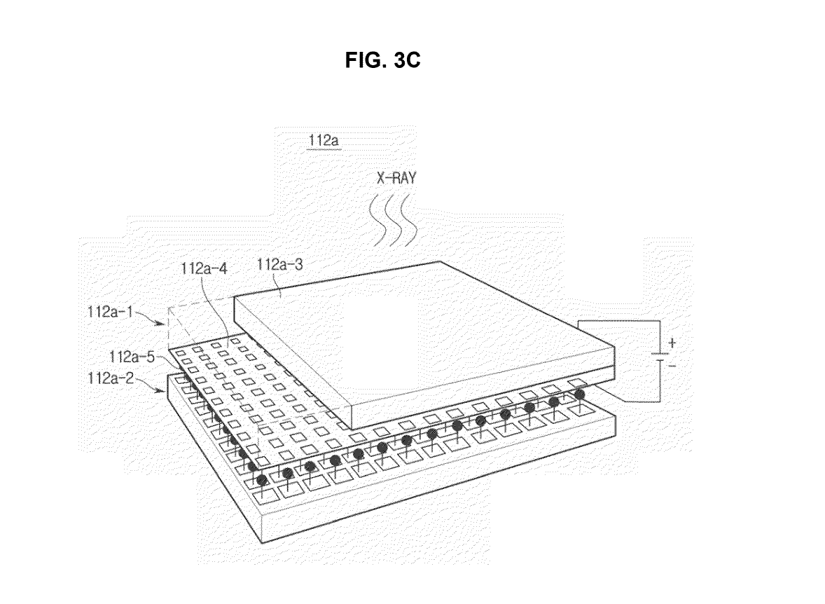

FIGS. 3A and 3B illustrate an exterior of the scanner 110 that performs tomosynthesis in accordance with an exemplary embodiment, and FIG. 3C illustrates a structure of a radioactive ray detector that detects X-rays in accordance with an exemplary embodiment.

When the scanner 110 performs tomosynthesis, the scanner 110 may have the structure illustrated in FIGS. 3A and 3B.

Referring to FIG. 3A, the scanner 110 includes the radioactive ray source 111 that generates radioactive rays and radiates the generated radioactive rays onto the object 30, and the radioactive ray detector module 112 that detects the radioactive rays transmitted by the object 30. The radioactive ray source 111 may generate X-rays, and an internal configuration thereof may be the same as previously described with reference to FIG. 2B.

Due to characteristics of a breast 30 including only soft tissues, the breast 30 as an object may be compressed using a compression paddle 107 to obtain a clearer image. The compression paddle 107 is movable in a vertical direction along a second arm 104b connected to the radioactive ray detector module 112. When the breast 30 is placed on the radioactive ray detector module 112, the compression paddle 107 moves downward and compresses the breast 30 to a predetermined thickness.

When the breast 30 is compressed, the radioactive ray source 111 radiates X-rays, and the X-rays transmitted by the breast 30 are detected by the radioactive ray detector module 112. The radioactive ray detector module 112 obtains the projection data from the detected X-rays and transmits the projection data to the image controller 120.

The scanner 110 scans the object 30 from a plurality of different viewpoints. Thus, to this end, a first arm 104a to which the radioactive ray source 111 is connected, may be rotated about a shaft 109 connected to a housing 102 at a predetermined angle, and X-rays are radiated onto the object 30. In this case, the radioactive ray detector module 112 may be fixed or may be rotated together. However, when the scanner 110 has a structure as illustrated in FIG. 3A, the radioactive ray detector module 112 is fixed, and only the radioactive ray source 111 is rotated.

Alternatively, as illustrated in FIG. 3B, when the scanner 110 may have a structure in which the radioactive ray source 111 and the radioactive ray detector module 112 are connected to the first arm 104a, the radioactive ray source 111 and the radioactive ray detector module 112 are rotated together.

The radioactive ray detector module 112 may include a radioactive ray detector that detects X-rays transmitted by the object 30 and may further include an X-ray grid (not shown) for preventing scattering of the X-rays.

Referring to FIG. 3C, a radioactive ray detector 112a includes a light receiving device 112a-1 that detects X-rays and converts the detected X-rays into electrical signals, and a reading circuit 112a-2 that reads the electrical signals. Here, the reading circuit 112a-2 has the shape of a two-dimensional pixel array including a plurality of pixel regions. A monocrystal semiconductor material may be used to provide the light receiving device 112a-1, to obtain higher resolution, a faster response time, and a wider dynamic region at lower energy and a lower radiation dose. Examples of the monocrystal semiconductor material include Ge, CdTe, CdZnTe, and GaAs.

The light receiving device 112a-1 may be provided in a PIN photodiode obtained by joining a p-type layer 112a-4 in which p-type semiconductors are arranged in a two-dimensional pixel array structure and a lower part of a higher resistance n-type semiconductor substrate 112a-3. The reading circuit 112a-2 using a complementary metal oxide semiconductor (CMOS) process is combined with the light receiving device 112a-1 according to pixels. The CMOS reading circuit 112a-2 and the light receiving device 112a-1 may be combined with each other in a flip chip bonding manner. Thus, the CMOS reading circuit 112a-2 and the light receiving device 112a-1 may be combined with each other by using a bump 112a-5 including, for example, Pb—Sn solder or indium (In), reflowing, heating, and compressing the bump 112a-5. However, the above-described structure is only an example of the radioactive ray detector 112a, and the structure of the radioactive ray detector 112a is not limited thereto.

The above-described structure of the radioactive ray detector 112a of FIG. 3C may also be applied to the scanner 110 that performs the CT imaging.

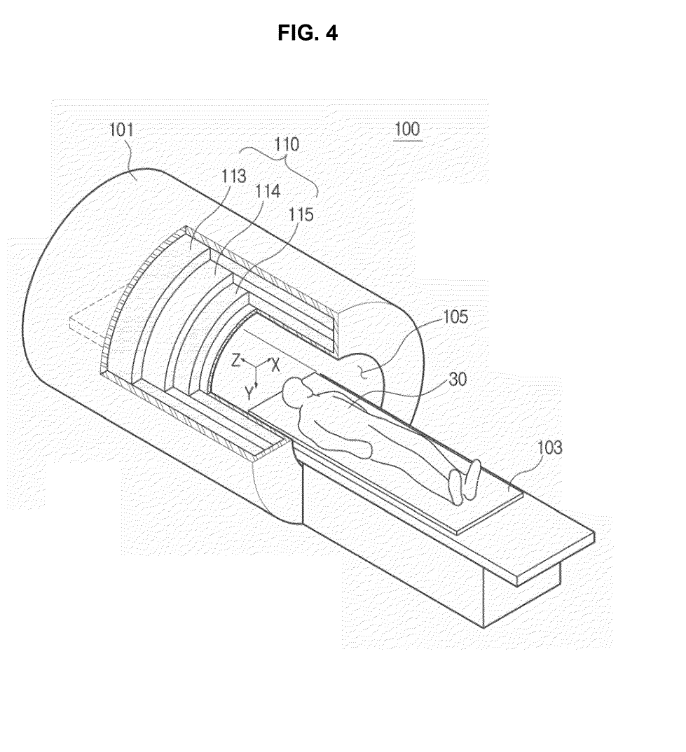

FIG. 4 illustrates an exterior of a scanner that uses magnetic resonance in accordance with an exemplary embodiment.

When the scanner 110 uses magnetic resonance, the scanner 110 includes a magnet assembly 110 that is mounted in the housing 101, as illustrated in FIG. 4. The magnet assembly 110 includes a static field coil 113 that forms a static field in the bore 105, a gradient coil 114 that forms a gradient field by generating a gradient in the static field, and an RF coil 115 that applies a radio frequency (RF) pulse, excites an atomic nucleus, and receives an echo signal from the atomic nucleus. That is, when the patient table 103 on which the object 30 is placed, is transported into an internal space of the bore 105, the static field, the gradient field, and the RF pulse are applied to the object 30, and the atomic nucleus that constitutes the object 30 is excited, and the echo signal is generated from the atomic nucleus. The RF coil 115 receives the echo signal from the atomic nucleus and transmits the echo signal to the image controller 120.

In the above, the configuration and the operation of the scanner 110 that obtains the projection data by scanning the object 30 have been described in detail. Hereinafter, a configuration and an operation of the image controller 120 that images the inside of the object 30 will be described in detail.

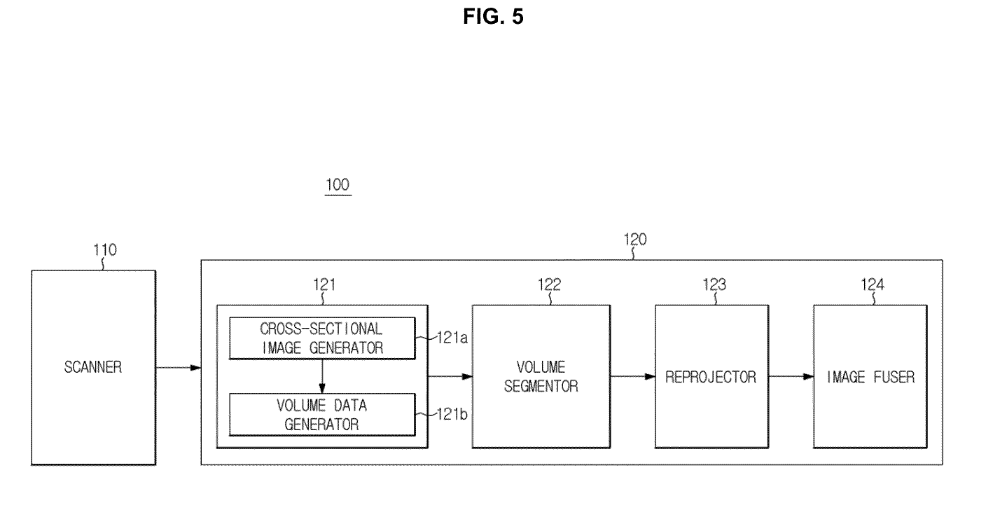

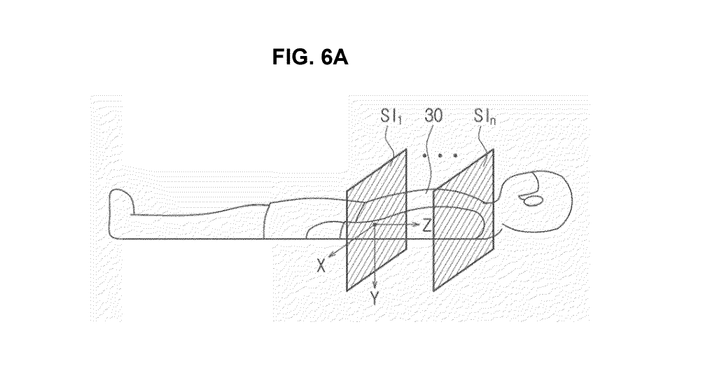

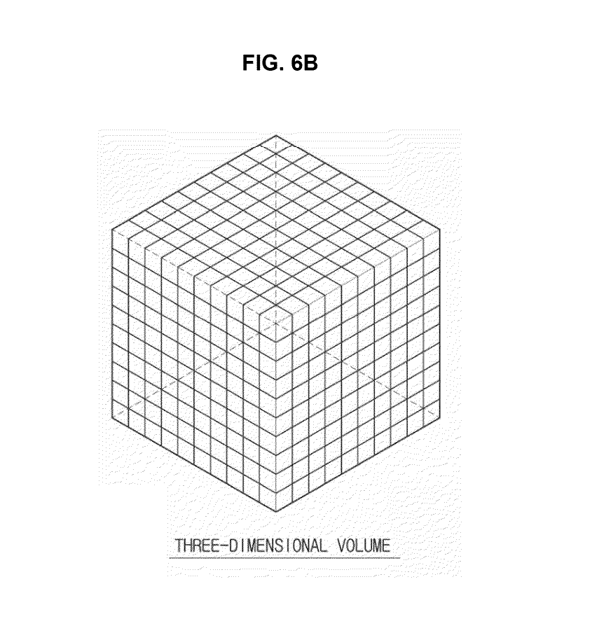

FIG. 5 is a detailed control block diagram of a medical imaging apparatus in accordance with an exemplary embodiment, and FIG. 6A schematically illustrates a cross-sectional image of the object 30 in accordance with an exemplary embodiment, and FIG. 6B schematically illustrates a volume of the restored object 30 in accordance with an exemplary embodiment.

The projection data obtained by scanning the object 30 using the scanner 110 is transmitted to the three-dimensional restorer 121. As illustrated in FIG. 5, the three-dimensional restorer 121 may include a cross-sectional image generator 121a that generates a cross-sectional image of the object 30 and a volume data generator 121b that generates volume data of the object 30 from the cross-sectional image of the object 30.

As described above, the scanner 110 obtains the projection data from a plurality of different viewpoints using a structure that rotates around a periphery of the object 30 at a predetermined angle or surrounds the object 30, whereas the cross-sectional image generator 121a may generate the cross-sectional image of the object 30 by reconstituting the projection data transmitted from the scanner 110. The cross-sectional image is also referred to as a tomography image and thus will be referred to a cross-sectional image in this embodiment for convenience of explanation.

Examples of a method of reconstituting the projection data using the cross-sectional image generator 121a include an iterative method, a direct Fourier transform method, a back projection method, and a filtered back-projection method.

The iterative method is a method, in which projection data is consecutively corrected until data closer to an original structure of an object is obtained, and the back projection method is a method, in which a plurality of projection data obtained from a plurality of viewpoints are back projected on one screen, and the direct Fourier transform method is a method, in which projection data is transformed from a spatial region to a frequency region. The filtered back-projection method is a method, in which back-projection is performed after filtering is performed to offset clouding cat the periphery of the center of projection data.

Scanning may not be limited to a region corresponding to one cross-sectional image when the object 30 is scanned, and thus, the cross-sectional image generator 121a may generate a plurality of cross-sectional images.

For example, referring to FIG. 6A, when the object 30 is a part of the human body and the human body is transferred to an inside of the bore 105 and is scanned, projection data may be obtained from a region having a predetermined area on an X-Y plane, and a plurality of cross-sectional images SI₁ to SIₙ of the object 30 on the X-Y plane may be generated in a Z-direction.

The volume data generator 121b restores the volume of the object 30 in a three-dimensional manner using the plurality of cross-sectional images SI₁ to SIₙ. When the plurality of cross-sectional images SI₁ to SIₙ are latitudinal cross-sectional images, the volume data generator 121b may restore the volume of the object 30 in the three-dimensional manner by accumulating the plurality of cross-sectional images SI₁ to SIₙ in a vertical axis direction. In FIG. 6A, the plurality of cross-sectional images SI₁ to SIₙ are accumulated in the Z-direction, thereby restoring the volume of the object 30 in the three-dimensional manner.

Referring to FIG. 6B, the volume of the object 30 may be represented as volume data arranged in the three-dimensional manner, and the volume data includes voxels having scalar values or vector values sampled at regular intervals.

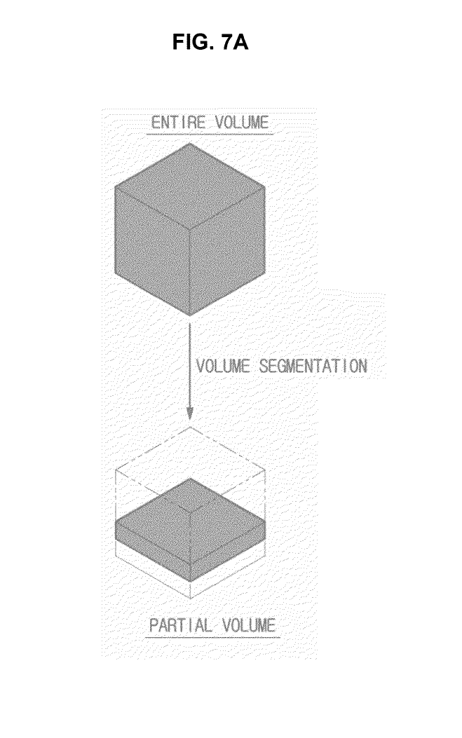

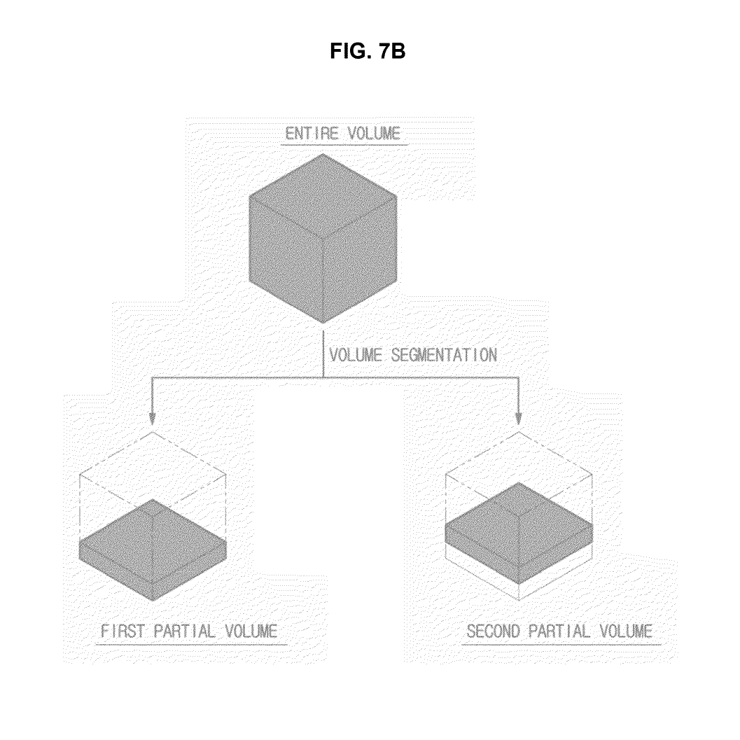

FIGS. 7A and 7B schematically illustrate a partial volume or partial volumes segmented from an entire volume of the object in accordance with exemplary embodiments.

Since an entire volume of the object 30 may include materials that that overlap each other, it may be difficult to accurately check the structure of the inside of the object 30 only from the entire volume. Thus, the volume segmentor 122 may generate a partial volume by partially segmenting the entire volume of the object 30, as illustrated in FIG. 7A. The partial volume means a part of the entire volume, and a volume or position thereof is not limited. In the following exemplary embodiment, the entire volume means the entire volume of the object 30 generated by the three-dimensional restorer 121.

Also, the volume segmentor 122 may generate two partial volumes (i.e., a first partial volume and a second partial volume) at different positions, as illustrated in FIG. 7B, or may generate two or more partial volumes. When two or more partial volumes are generated, the two or more partial volumes may be a part of the entire volume at different positions, and volumes thereof need not to be same.

The positions or volumes of the partial volumes segmented by the volume segmentor 122 may be selected by a user, and thus descriptions thereof will be provided below.

The reprojector 123 may generate reprojection images by reprojecting the entire volume or partial volume(s) from a plurality of virtual viewpoints. The reprojector 123 may generate the reprojection images using a volume rendering technique. In detail, a volume rendering technique such as ray casting or ray tracing may be used. Here, rays may be X-rays, thereby obtaining projection images regarding an inside of the volume of the object.

For example, the reprojector 123 may generate virtual projection images by radiating virtual X-rays onto the entire volume or partial volume(s). To this end, at least one reprojection condition from among a virtual position of an X-ray source, a virtual distance between the X-ray source and the entire volume or partial volume(s), a virtual projection angle, a virtual viewpoint interval, the number of virtual viewpoints, and resolution of a volume may be set, and virtual X-rays may be radiated onto the entire volume or partial volume(s) on the set reprojection condition.

The number of virtual viewpoints may be set according to an output format of a three-dimensional display device of the medical imaging apparatus 100, and the virtual viewpoint interval may be set based on an average distance between eyes of the human body, for example, 6.5 cm.

Thus, when the entire volume or partial volume(s) generated by the volume segmentor 122 is input to the reprojector 123, the reprojector 123 may generate reprojection images corresponding to the set reprojection condition. The reprojection condition may also be set by the reprojector 123 or may be set or changed according to the user's instruction. In an exemplary embodiment, the user may be a member of a medical team that performs diagnosis of the subject using the medical imaging apparatus 100. For example, the user may be a doctor, a radiological instrument technician, or a nurse. However, exemplary embodiments are not limited thereto, and anyone who uses the medical imaging apparatus 100 may be the user.

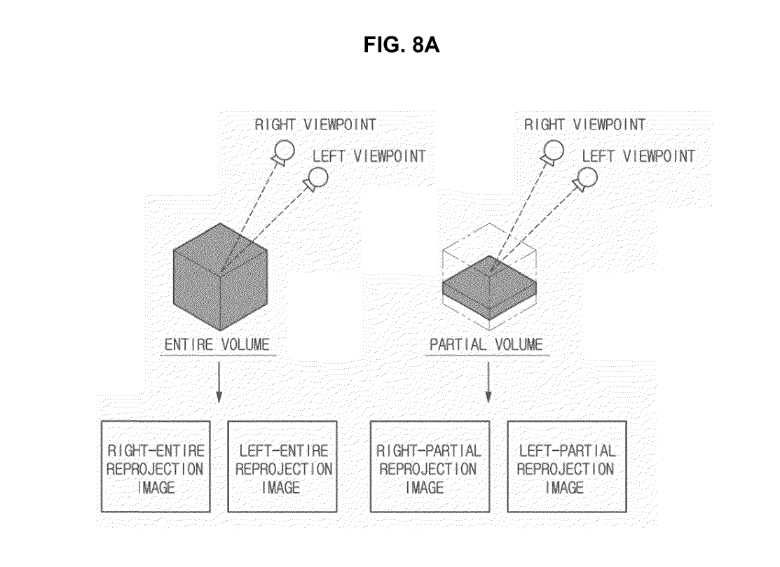

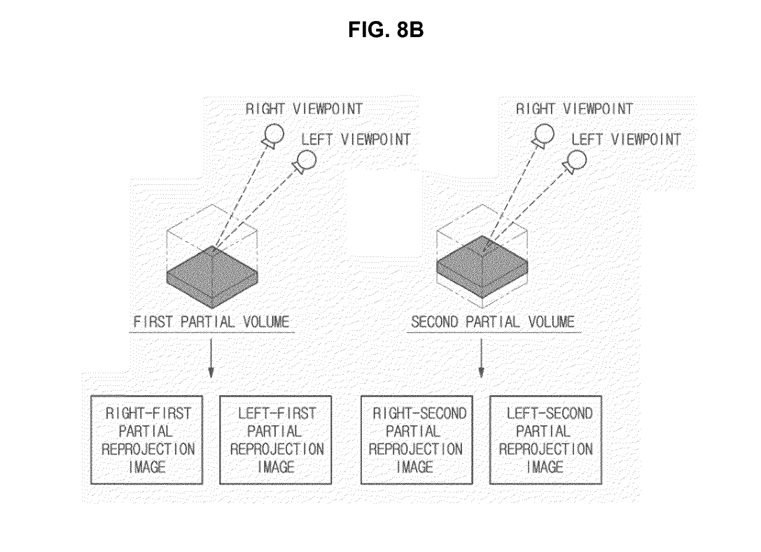

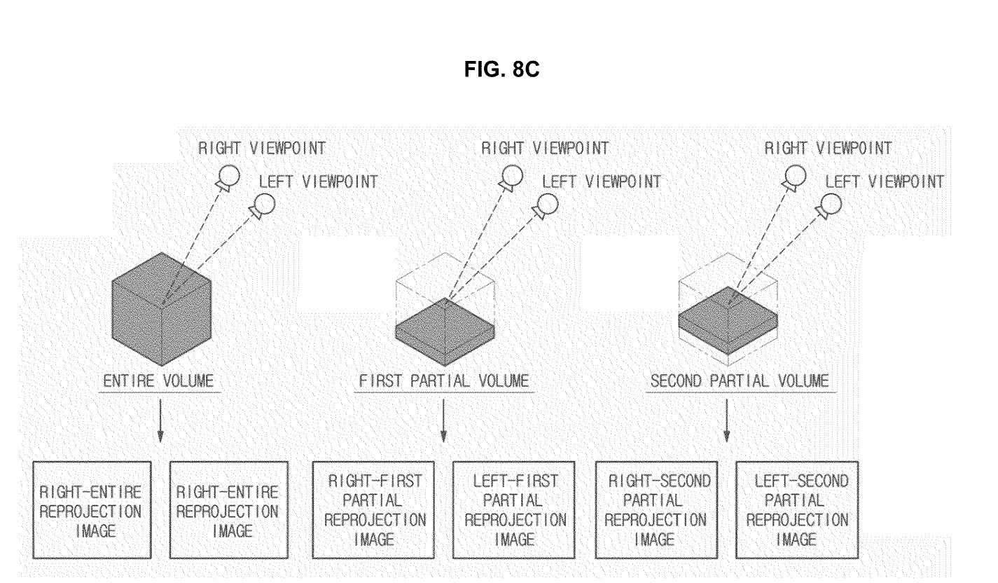

FIGS. 8A through 8C schematically illustrate an operation of reprojecting an entire volume or partial volume(s) from a right viewpoint and a left viewpoint in accordance with exemplary embodiments. When a volume is reprojected from the right viewpoint and the left viewpoint that correspond to a right eye and a left eye of the human body, the volume may be displayed on a three-dimensional display device using a stereoscopic method in a three-dimensional manner.

As illustrated in FIG. 7A described above, when a partial volume is segmented from the entire volume, the reprojector 123 may reproject the entire volume and the partial volume from the right viewpoint and the left viewpoint, respectively, as illustrated in FIG. 8A. An image obtained by reprojecting the entire volume from the right viewpoint is referred to as a right-entire reprojection image, and an image obtained by reprojecting the entire volume from the left viewpoint is referred to as a left-entire reprojection image. Also, an image obtained by reprojecting the partial volume from the right viewpoint is referred to as a right-partial reprojection image, and an image obtained by reprojecting the partial volume from the left viewpoint is referred to as a left-partial reprojection image.

Alternatively, as illustrated in FIG. 7B described above, when two partial volumes are segmented from the entire volume, the reprojector 123 may reproject a first partial volume and a second partial volume from the right viewpoint and the left viewpoint, respectively, as illustrated in FIG. 8B. An image obtained by reprojecting the first partial volume from the right viewpoint is referred to as a right-first partial reprojection image, and an image obtained by reprojecting the first partial volume from the left viewpoint is referred to as a left-first partial reprojection image. Also, an image obtained by reprojecting the second partial volume from the right viewpoint is referred to as a right-second partial reprojection image, and an image obtained by reprojecting the second partial volume from the left viewpoint is referred to as a left-second partial reprojection image.

Also, the reprojector 123 may generate a right-entire reprojection image, a left-entire reprojection image, a right-first partial reprojection image, a left-first partial reprojection image, a right-second partial reprojection image, and a left-second partial reprojection image by reprojecting the entire volume, the first partial volume, and the second partial volume from the right viewpoint and the left viewpoint, respectively, as illustrated in FIG. 8C.

That is, when two or more partial volumes are segmented by the volume segmentor 122, the reprojector 123 may reproject the segmented partial volumes and entire volume, as illustrated in FIG. 8C, or may reproject a part of the segmented partial volumes and entire volume, as illustrated in FIG. 8B.

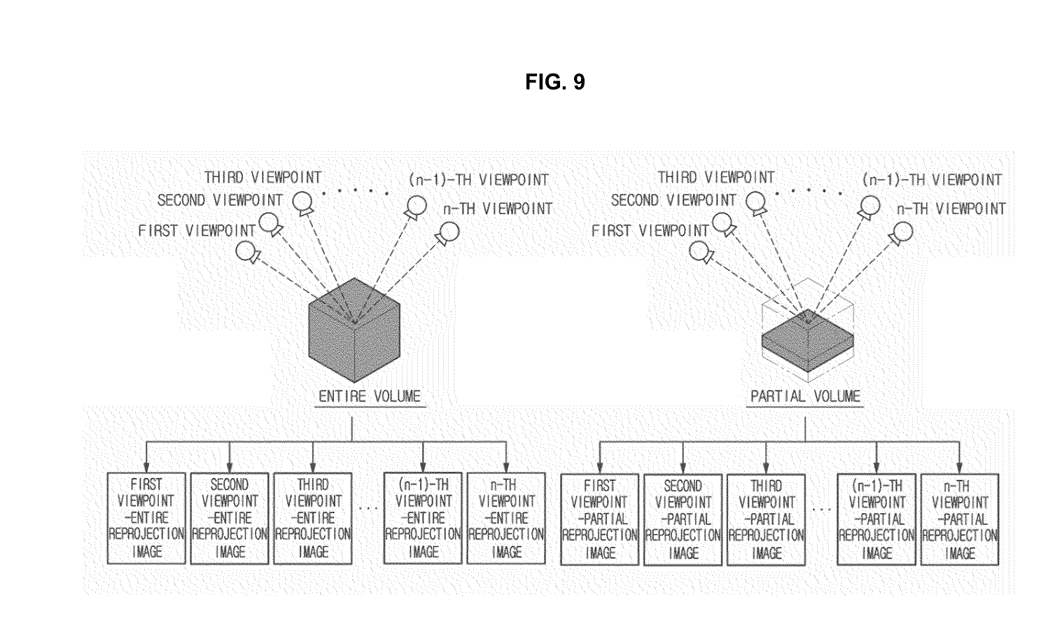

FIG. 9 schematically illustrates an operation of reprojecting an entire volume or a partial volume from a plurality of viewpoints in accordance with an exemplary embodiment.

When an output format of the three-dimensional display device is an autostereoscopic type without using 3D glasses, as illustrated in FIG. 9, the reprojector 123 may reproject each of the entire volume and the partial volume from n viewpoints (n≧3, n is an integer) including first through n-th viewpoints. When the entire volume is reprojected from the first viewpoint through the n-th viewpoint, respectively, a first viewpoint-entire reprojection image through an n-th viewpoint-entire reprojection image are generated, and when the partial volume is reprojected from the first viewpoint through the n-th viewpoint, respectively, a first viewpoint-partial reprojection image through an n-th viewpoint-partial reprojection image are generated. That is, in the exemplary embodiment of FIG. 9, n reprojection images are generated according to each volume, and two reprojection images are generated according to each viewpoint.

When the volume segmentor 122 segments two or more partial volumes from the entire volume, as described with reference to FIGS. 8B and 8C above, two or more partial volumes may be reprojected, or the entire volume and two or more partial volumes may be reprojected. Similarly, when the output format of the three-dimensional display device is the autostereoscopic type, two or more partial volumes may be reprojected from a plurality of viewpoints, or the entire volume and two or more partial volumes may be reprojected from a plurality of viewpoints.

The image fuser 124 fuses a plurality of reprojection images according to viewpoints and generates fusion images according to the viewpoints. Image fusion may be performed by using at least one of various image fusion techniques. Examples of image fusion techniques may include average, weighted average, edge preserving fusion, and maximum selection.

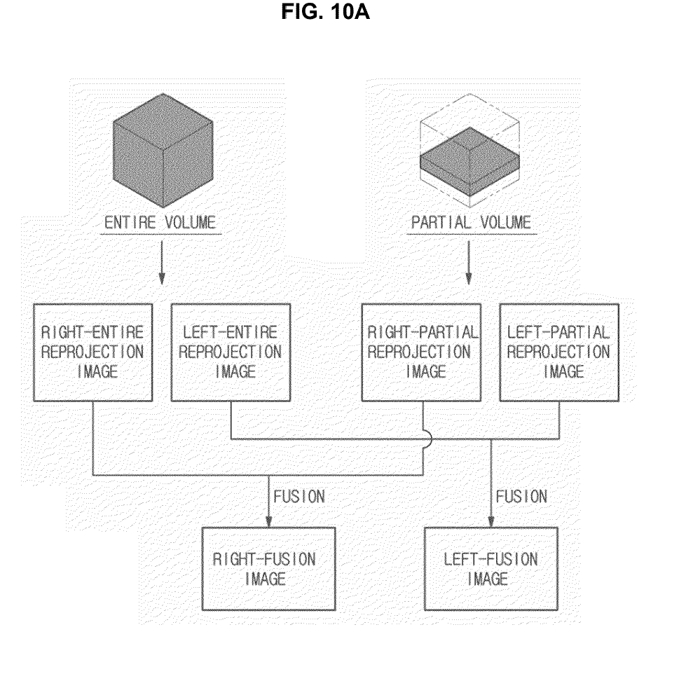

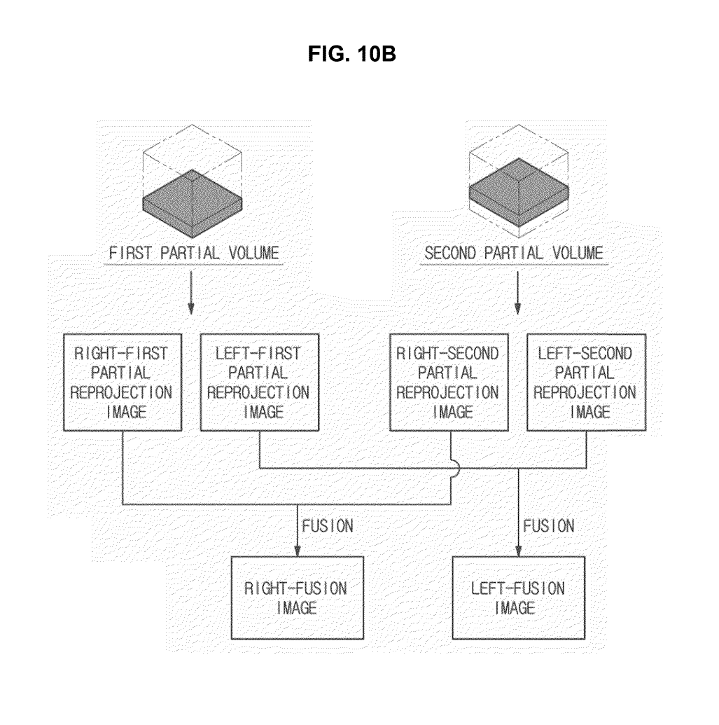

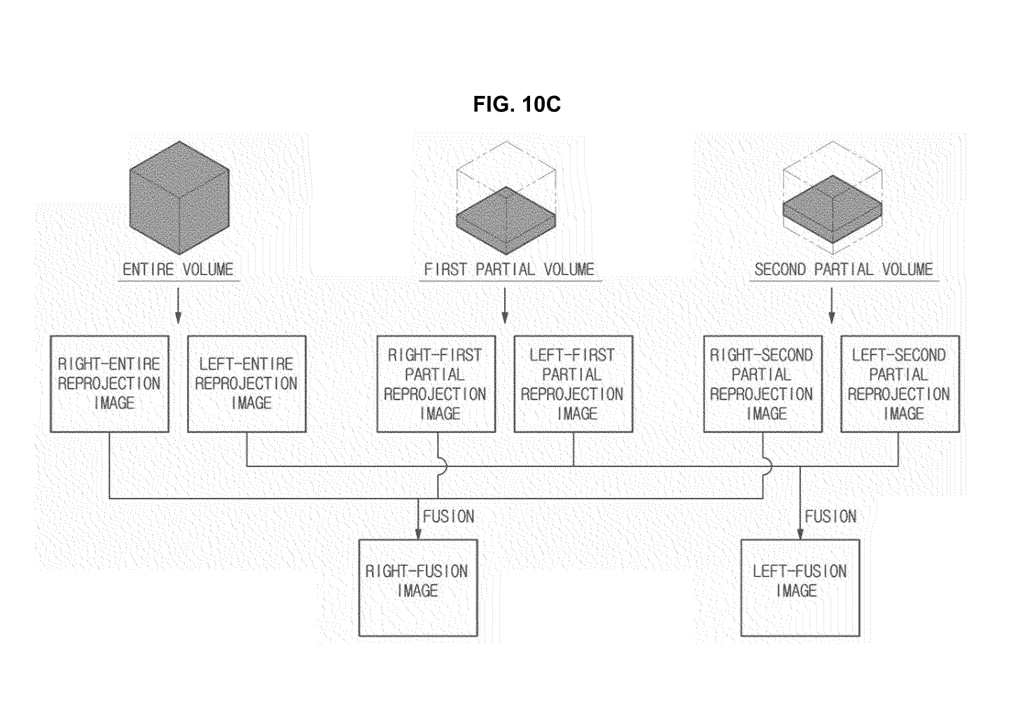

FIGS. 10A through 10C schematically illustrate an operation of fusing the reprojection images from a right viewpoint and a left viewpoint in accordance with exemplary embodiments.

The image fuser 124 generates fusion images according to virtual viewpoints by fusing the reprojection images from the same virtual viewpoints. As described above in FIG. 8A, when the reprojector 123 generates the right-entire reprojection image and the left-entire reprojection image from the entire volume and generates the right-partial reprojection image and the left-partial reprojection image from the partial volume, the image fuser 124 may generate a fusion image (i.e., right-fusion image) corresponding to the right viewpoint by fusing the right-entire reprojection image and the right-partial reprojection image and may generate a fusion image (i.e., left-fusion image) corresponding to the left viewpoint by fusing the left-entire reprojection image and the left-partial reprojection image, as illustrated in FIG. 10A.

Alternatively, as described above in FIG. 8B, when the volume segmentor 122 segments the first partial volume and the second partial volume from the entire volume and the reprojector 123 reprojects the first partial volume and the second partial volume from the right viewpoint and the left viewpoint to generate the right-first partial reprojection image, the left-first partial reprojection image, the right-second partial reprojection image, and the left-second partial reprojection image, the image fuser 124 may generate a right-fusion image by fusing the right-first partial reprojection image and the right-second partial reprojection image and may generate a left-fusion image by fusing the left-first partial reprojection image and the left-second partial reprojection image, as illustrated in FIG. 10B.

Alternatively, as described above in FIG. 8C, when the reprojector 123 reprojects the entire volume and the first and second partial volumes from the right viewpoint and the left viewpoint to generate the right-entire reprojection image, the right-first partial reprojection image, the left-first partial reprojection image, the left-entire reprojection image, the right-second partial reprojection image, and the left-second partial reprojection image, the image fuser 124 may generate a right-fusion image by fusing the right-entire reprojection image, the right-first partial reprojection image, and the right-second partial reprojection image and may generate a left-fusion image by fusing the left-entire reprojection image, the left-first partial reprojection image, and the left-second partial reprojection image, as illustrated in FIG. 10C.

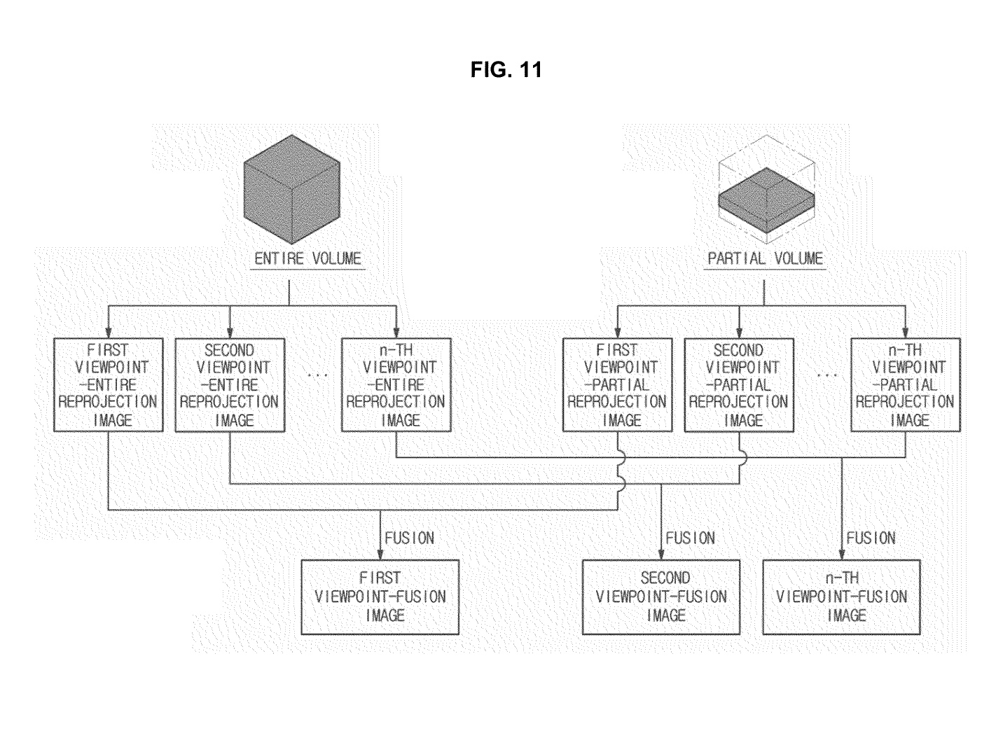

FIG. 11 schematically illustrates an operation of fusing images reprojected from a plurality of viewpoints in accordance with an exemplary embodiment.

As described above in FIG. 9, when the reprojector 123 reprojects the entire volume and the partial volume from n viewpoints, the image fuser 124 may generate a first viewpoint-fusion image by fusing a first viewpoint-entire reprojection image and a first viewpoint-partial reprojection image, may generate a second viewpoint-fusion image by fusing a second viewpoint-entire reprojection image and a second viewpoint-partial reprojection image. In a similar manner, the image fuser 124 may generate a third viewpoint-fusion image through an n-th viewpoint-fusion image, as illustrated in FIG. 11.

When the volume segmentor 122 segments three or more partial volumes, the partial volumes may be reprojected from a plurality of viewpoints, or the partial volumes and the entire volume may be reprojected from the plurality of viewpoints.

When the reprojection images are fused using one of the above-described image fusion techniques, an entire three-dimensional contour of the object may be represented, and also, an image of the object having higher contrast may be provided.

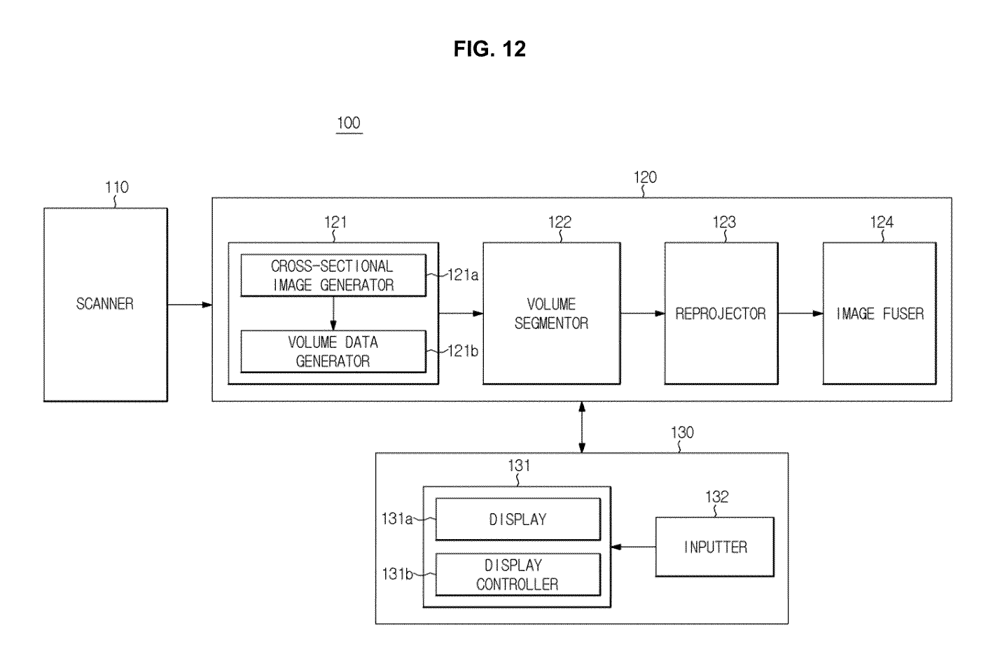

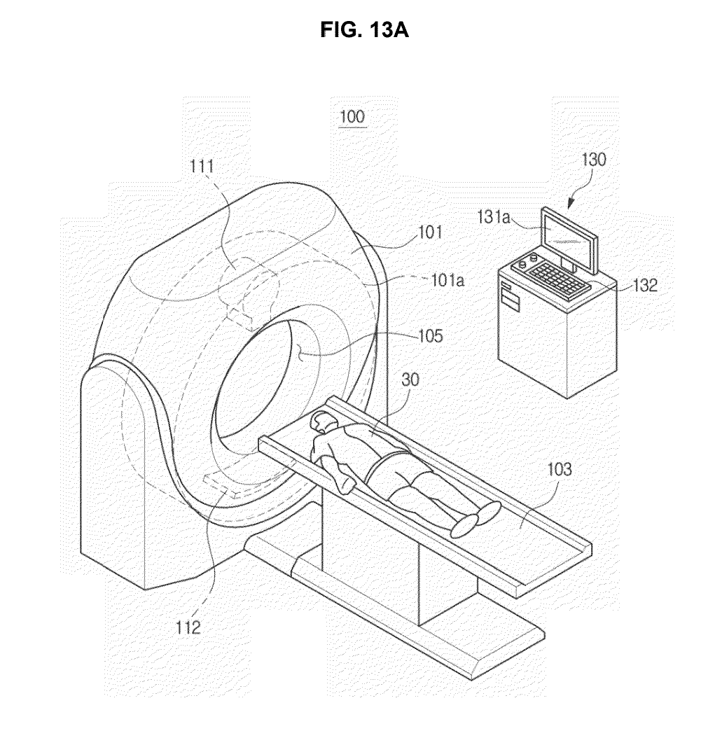

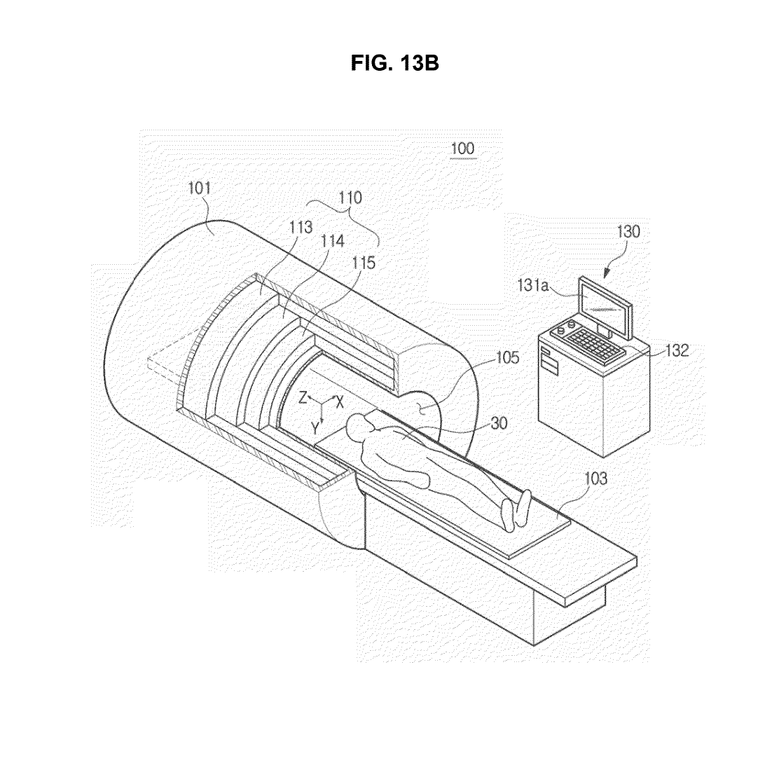

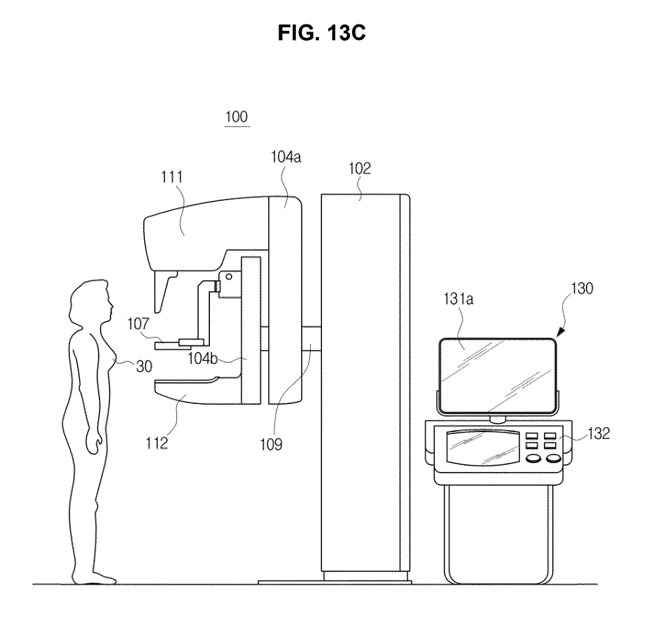

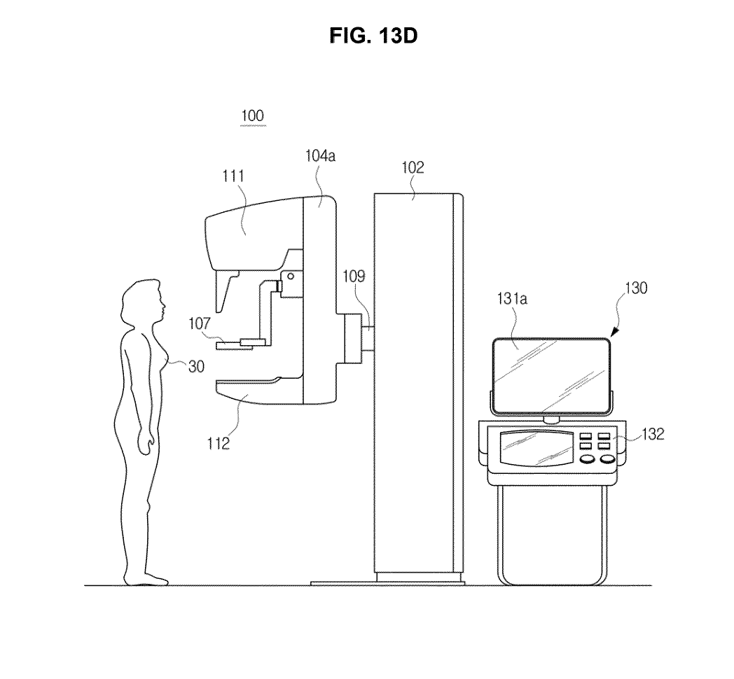

FIG. 12 is a control block diagram of a medical imaging apparatus that further includes a host device in accordance with another exemplary embodiment, and FIGS. 13A through 13D illustrate an exterior of a medical imaging apparatus that further includes the host device in accordance with exemplary embodiments.

Referring to FIG. 12 and FIGS. 13A through 13D, the medical imaging apparatus 100 in accordance with an exemplary embodiment further includes a host device 130 that includes a user interface. The host device 130 may control an overall operation of the medical imaging apparatus 100, and provide a three-dimensional image inside the object to the user.

The host device 130 may include a display device 131 that displays reprojection images or fusion images according to viewpoints in a three-dimensional manner, and an inputter 132 to which control instructions are input from the user. The display unit 131 may be implemented with a three-dimensional display device. The display unit 131 includes a display 131a and a display controller 131b that controls the display 131a to display an image in the three-dimensional manner. In an exemplary embodiment, displaying of the image in the three-dimensional manner means displaying the image such that the user may feel a three-dimensional effect using a stereoscopic or autostereoscopic method.

The display device 131 may display the image in the three-dimensional manner using at least one of various output formats. For example, the display device 131 may display the reprojection images or the fusion images according to viewpoints in the three-dimensional manner using a stereoscopic method using 3D glasses or an autostereoscopic method without using 3D glasses. The stereoscopic method may be classified into a polarization method and a shutter glass method according to a type of 3D glasses, and the autostereoscopic method may be classified into a multi-view method, a volumetric method, and an integral image method.

As described above, the number of virtual viewpoints to be reprojected may be determined based on an output format of the three-dimensional display device of the medical imaging apparatus 100. For example, when the stereoscopic method using 3D glasses is used, as illustrated in FIGS. 8A through 8C, an entire volume or a partial volume is reprojected from the left viewpoint and the right viewpoint, and a fusion image corresponding to the left viewpoint is generated by fusing reprojection images from the left viewpoint, and a fusion image corresponding to the right viewpoint is generated by fusing reprojection images from the right viewpoint, as illustrated in FIGS. 10A through 10C.

The display device 131 may display the fusion image corresponding to the left viewpoint and the fusion image corresponding to the right viewpoint but may also display an unfused reprojection image. For example, the display device 131 may display the reprojection image of the entire volume from the left viewpoint and the reprojection image of the entire volume from the right viewpoint and may allow the user to check the entire structure of the object in the three-dimensional manner, and may display the reprojection image of the partial volume from the left viewpoint and the reprojection image of the partial volume from the right viewpoint and may allow the user to check the detailed internal structure of the object in the three-dimensional manner.

When the polarization method of the stereoscopic method using 3D glasses is used, the display controller 131b may divide scanning lines that constitute the display 131a into even number lines and odd number lines and control the fusion image corresponding to the left viewpoint and the fusion image corresponding to the right viewpoint to be displayed in the respective scanning lines. A filter that may output two separated images may be attached to a front side of the display 131a, and different polarizers may be mounted on a left lens and a right lens of 3D glasses. Thus, the fusion image corresponding to the left viewpoint may be viewable only through the left lens, and the fusion image corresponding to the right viewpoint may be viewable only through the right lens.

When the shutter glass method of the stereoscopic method using 3D glasses is used, the display controller 131b may control the fusion image corresponding to the left viewpoint and the fusion image corresponding to the right viewpoint to be alternately displayed on the display 131a. In this case, a shutter mounted on the 3D glasses may be synchronized with the display device 131 and selectively opened or closed depending on whether the fusion image displayed on the display device 131 is a left viewpoint fusion image or a right viewpoint fusion image.

When the multi-view method of the autostereoscopic method without using 3D glasses is used, as illustrated in FIG. 9 described above, the entire volume and the partial volume may be reprojected from first through n-viewpoints, and fusion images corresponding to the plurality of viewpoints are generated by fusing the reprojection images according to the viewpoints, as illustrated in FIG. 11.

The display controller 131b may weave the fusion images corresponding to the plurality of viewpoints and display the weaved fusion images on the display 131a. Weaving is a technique to weave a plurality of images from different viewpoints. When the weaved images are displayed on the display 131a, a viewer may feel different three-dimensional effects according to a viewpoint at which the viewer views the display 131a.

The inputter 132 may receive instructions regarding image control from the user and may be implemented with, for example, a mouse, a keyboard, a track ball, a touch panel and/or one or more buttons. When the display 131a is implemented with a touch screen, the display 131a may also perform the function of the inputter 132.

In detail, the inputter 132 may receive selection regarding the partial volume(s) segmented by the volume segmentor 122 from the user. For example, when the display 131a renders and displays the entire volume of the object or reprojects the entire volume of the object from a plurality of viewpoints and displays the reprojected entire volume of the object in the three-dimensional manner, the user may select a part from among the displayed entire volume of the object or the displayed reprojected entire volume. The user may designate a region corresponding to a desired part using the inputter 132, for example, the mouse or track ball or by directly touching the desired part on the touch screen, or may input position data indicating the region using the keyboard.

Based on the user's selection, the volume segmentor 122 may segment the volume of the selected part from the entire volume.

Also, the inputter 132 may receive selection regarding reprojection images to be fused from the user. For example, when the volume segmentor 122 segments two or more partial volumes, and the user selects reprojection images to be fused from among reprojection images of the entire volume and reprojection images of two or more partial volumes, the image fuser 124 fuses the selected reprojection images according to virtual viewpoints, and the fused reprojection images are displayed through the display device 131. For example, as described above in FIGS. 10B and 10C, the reprojection image of the first partial volume and the reprojection image of the second partial volume may be fused, or the reprojection image of the entire volume, the reprojection image of the first partial volume, and the reprojection image of the second partial volume may be fused. In this case, selection of the reprojection images to be fused may be performed by the inputter 132, and when selection of two or more volumes is performed from among the entire volume and the partial volume, reprojection images of the selected volumes are fused according to virtual viewpoints.

Also, the inputter 132 may receive selection of images to be displayed on the display device 131 from the user. For example, when the user selects the entire volume, the display device 131 may display the reprojection images according to virtual viewpoints regarding the entire volume in the three-dimensional manner, and when the user selects a partial volume, the display device 131 may display the reprojection images according to viewpoints regarding the selected partial volume in the three-dimensional manner. When the user selects the fusion images, the display device 131 may display the fusion images generated by the image fuser 124, and image fusion by the image fuser 124 may also be performed according to the user's selection, as described above.

In detail, when the user selects fusion images of the entire volume and the partial volume or fusion images of the partial volumes, the display device 131 may display the right-fusion image and the left-fusion image illustrated in FIGS. 10A through 10C or may display the first viewpoint-fusion image to the n-th viewpoint-fusion image illustrated in FIG. 11, according to an output format of the display device 131.

That is, the display device 131 may display a reprojection image regarding an individual volume in the three-dimensional manner according to the user's selection or may fuse and display reprojection images regarding to two or more different volumes in the three-dimensional manner. Thus, the user may select and obtain an appropriate image according to a diagnosis purpose.

Hereinafter, a method of controlling the medical imaging apparatus 100, in accordance with an exemplary embodiment will be described.

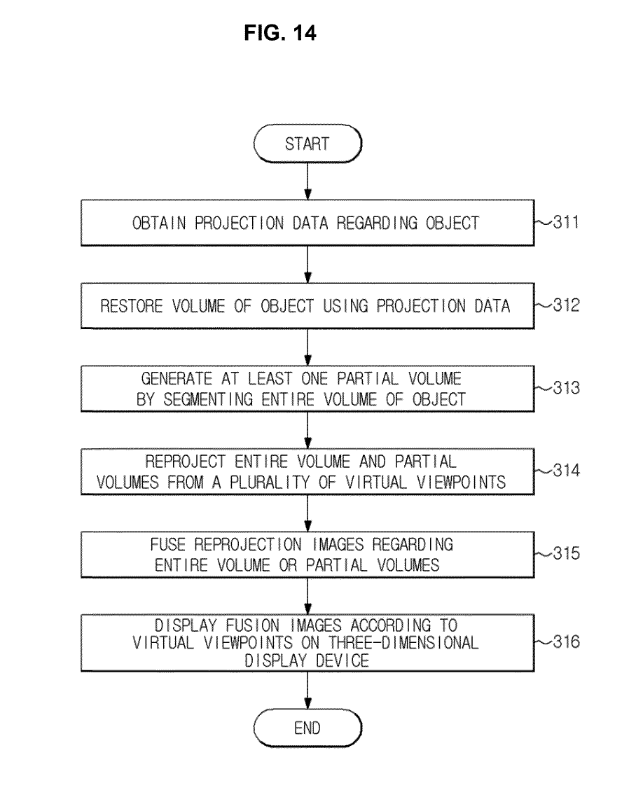

FIG. 14 is a flowchart illustrating a method of controlling a medical imaging apparatus, in accordance with an exemplary embodiment.

Referring to FIG. 14, projection data regarding an object is obtained (311). The projection data may be obtained by scanning the object from a plurality of different viewpoints. For example, scanning of the object may be performed by at least one from among computed tomography (CT) imaging, positron emission tomography (PET), and tomosynthesis using radioactive rays, or magnetic resonance imaging.

The volume of the object is restored using the projection data (312). To restore the volume of the object, projection data may be reconstituted according to a plurality of viewpoints to generate a plurality of cross-sectional images, and the plurality of cross-sectional images may be accumulated to generate volume data. The volume of the object is represented by the volume data arranged in a three-dimensional manner. Descriptions of reconstitution of the projection data and generation of the volume data may be the same as the above descriptions of the medical imaging apparatus 100, and thus detailed descriptions thereof will be omitted.

At least one partial volume is generated by segmenting the entire volume of the object (313). The partial volume may be a part of the entire volume, and a volume or a position thereof is not limited. For example, when two or more partial volumes are generated, positions of the two or more partial volumes may be different. In an exemplary embodiment, volumes or positions of partial volumes to be segmented may be selected by the user. The user may input selection regarding parts to be segmented from among the entire volume through the inputter 132 of the medical imaging apparatus 100.

The partial volumes and/or the entire volume are reprojected from a plurality of virtual viewpoints (314). The number of virtual viewpoints to be reprojected may be determined by an output format of the three-dimensional display device of the medical imaging apparatus 100. As an example of reprojection, ray tracing may be used. When a condition for reprojection may be set, virtual rays may be radiated onto the entire volume and the partial volume on the set reprojection condition, thereby generating reprojection images. The condition for reprojection may be set and changed by the user, and the user may input the condition for reprojection through the inputter 132.

Reprojection images regarding the partial volumes and/or the entire volumes are fused (315). In detail, reprojection images regarding two or more volumes among at least one partial volume and/or the entire volume are fused according to virtual viewpoints, thereby generating fusion images. When there is a partial volume, reprojection images regarding the entire volume and the partial volume may be fused, and when there are two or more partial volumes, reprojection images regarding all or a part of the partial volumes may be fused, or reprojection images regarding the entire volume and reprojection images regarding all or a part of the partial volumes may be fused. Image fusion may be performed using at least one of various image fusion techniques.

The fusion images according to virtual viewpoints are displayed on the three-dimensional display device (316). The three-dimensional display device may display the fusion images according to the plurality of virtual viewpoints in the three-dimensional manner using at least one of various output formats. For example, when a stereoscopic method using 3D glasses is used, the three-dimensional display device may substantially simultaneously or alternately display a fusion image corresponding to the left viewpoint and a fusion image corresponding to the right viewpoint such that the user who wears the 3D glasses may view the internal structure of the object in the three-dimensional manner. Also, when an autostereoscopic method without using 3D glasses is used, the three-dimensional display device may weave fusion images corresponding to n viewpoints such that the user may view the internal structure of the object in the three-dimensional manner without wearing the 3D glasses.

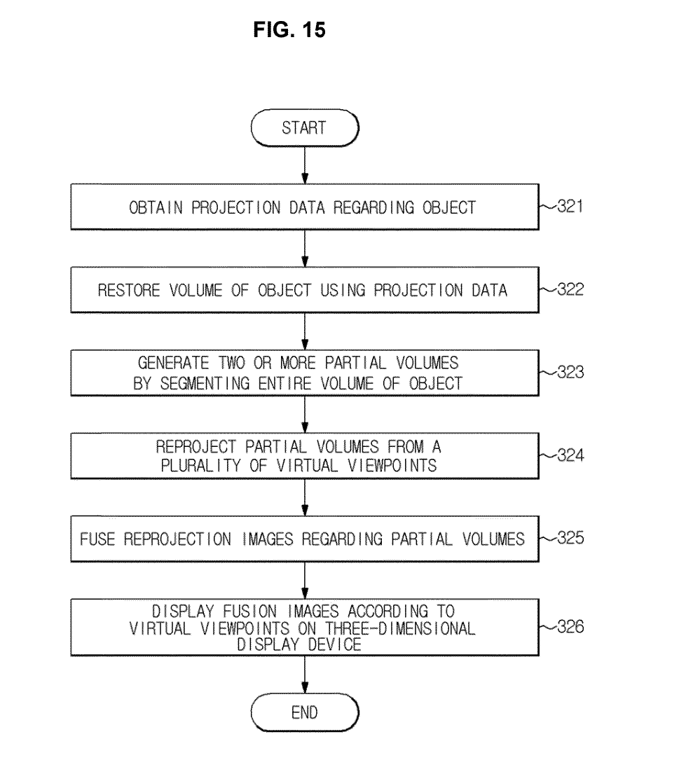

FIG. 15 a flowchart illustrating a method of controlling a medical imaging apparatus that fuses and displays partial volumes in accordance with another exemplary embodiment.

Referring to FIG. 15, projection data regarding an object is obtained (321). The volume of the object is restored using the projection data (322). To restore the volume of the object, the projection data is reconstituted to generate a plurality of cross-sectional images, and volume data of the object is generated using the plurality of cross-sectional images.

Two or more partial volumes are generated by partially segmenting the entire volume of the object (323). In this case, the segmented partial volumes may be selected by the user.

A plurality of partial volumes are reprojected from a plurality of virtual viewpoints (324), and reprojection images regarding the partial volumes are fused (325). In this case, at least one of various image fusion techniques may be used, and a particular part may appear clearer as needed, thereby improving contrast.

Fusion images according to virtual viewpoints are displayed on the three-dimensional display device (326). When fusion images obtained by fusing the partial volumes are displayed on the three-dimensional display device, the user may easily check the contour and the internal structure of a particular part for diagnosis.

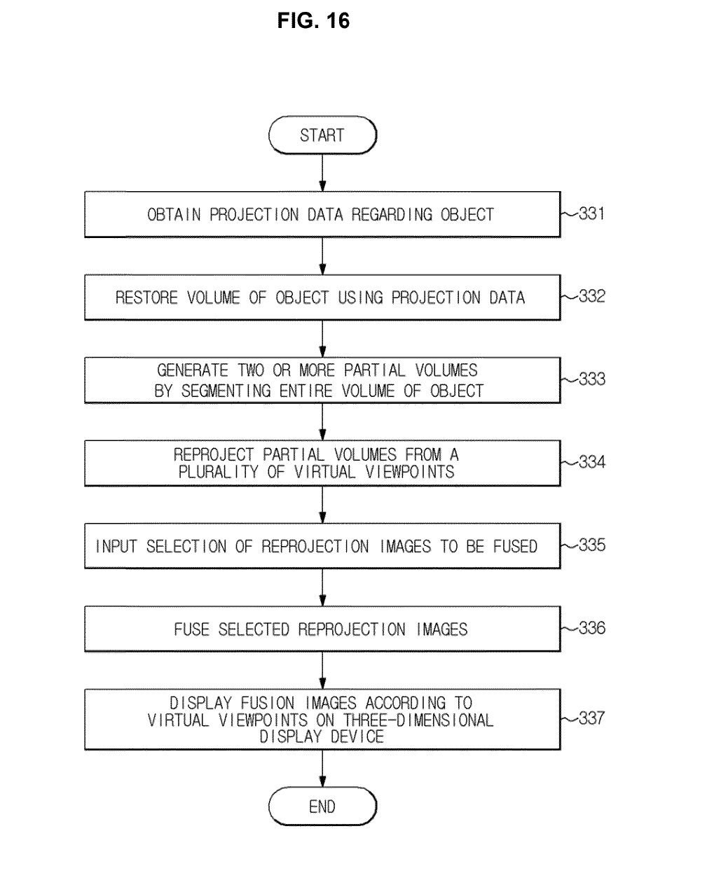

FIG. 16 is a flowchart illustrating a method of controlling a medical imaging apparatus in which a user may select an image for fusion in accordance with another exemplary embodiment.

Referring to FIG. 16, projection data regarding an object is obtained (331), and the volume of the object is restored using the projection data (332). Descriptions of restoring of the volume of the object may be the same as the above-described exemplary embodiment.

Two or more partial volumes are generated by partially segmenting the entire volume of the object (333). The volumes or positions of the segmented partial volumes may also be selected by the user.

The partial volumes are reprojected from a plurality of virtual viewpoints (334). Alternatively, the entire volume may be reprojected from a plurality of viewpoints and reprojection images of the entire volume and/or reprojection images of the partial volumes may be fused. The number of virtual viewpoints for reprojection may be determined by the output format of the three-dimensional display device of the medical imaging apparatus 100.

Selection of reprojection images to be fused is input (335). Selection of the reprojection images may be input by the inputter 132, and the user may select reprojection images according to a diagnosis purpose.

The selected reprojection images are fused according to virtual viewpoints (336), and fusion images according to virtual viewpoints are displayed on the three-dimensional display device (337). For example, when the entire volume and two or more partial volumes are selected, reprojection images regarding the entire volume and reprojection images regarding two or more partial volumes are fused according to virtual viewpoints and are displayed on the three-dimensional display device. Alternatively, when all or a part of two or more partial volumes are selected, reprojection images regarding the selected partial volumes are fused according to virtual viewpoints and are displayed on the three-dimensional display device.

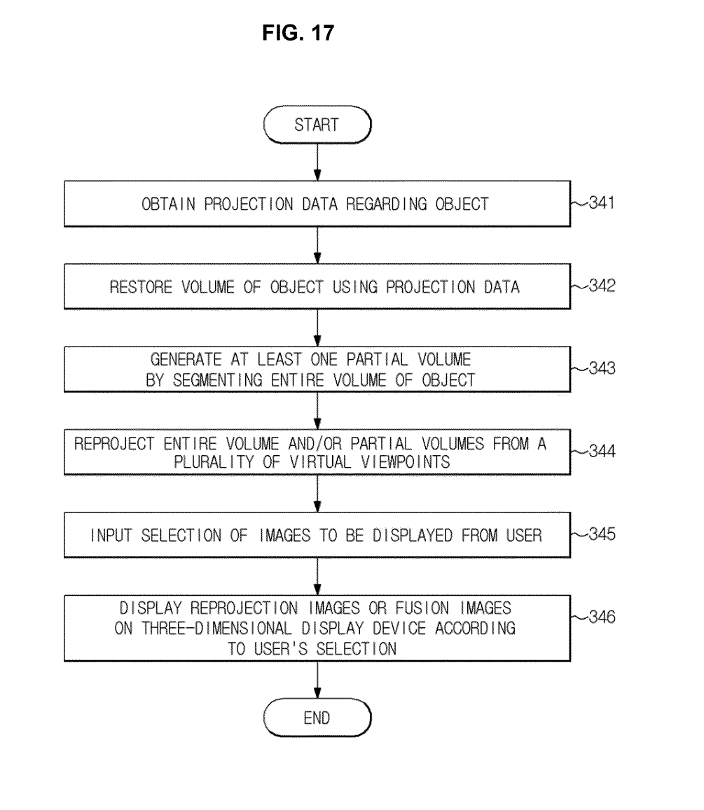

FIG. 17 is a flowchart illustrating a method of controlling a medical imaging apparatus in which a user may select an image to be displayed in accordance with another exemplary embodiment.

Referring to FIG. 17, projection data regarding an object is obtained (341), and the volume of the object is restored using the projection data (342). At least one partial volume is generated by partially segmenting the entire volume of the object (343), and the entire volume and/or the partial volumes are reprojected from a plurality of virtual viewpoints (344).

Selection of images to be displayed is input from the user (345). Selection of the images to be displayed may be input by the inputter 132, and the user may select an image according to a diagnosis purpose. For example, the user may select reprojection images and/or fusion images, and when the user selects the reprojection images, the user may select at least one from among the entire volume and at least one partial volume, and when the user selects the fusion images, the user may select the reprojection images to be fused.

The reprojection images or the fusion images are displayed on the three-dimensional display device according to the user's selection (346). Since the reprojection images are obtained from a plurality of virtual viewpoints, when the reprojection images are displayed without being fused with other reprojection images, the reprojection images may be displayed in the three-dimensional manner. For example, when the user selects the reprojection image regarding the entire volume or the partial volume, the selected reprojection image may be displayed, and when the user selects the fusion image, a previously-fused fusion image may be displayed, or reprojection images regarding two or more volumes among the entire volume and the partial volume may be fused and displayed according to the user's selection. For example, when the user selects all of the entire volume and the partial volume, reprojection images regarding the entire volume and reprojection images regarding the partial volume may be fused according to virtual viewpoints and displayed, and when the user selects a part from among the entire volume and the partial volume, reprojection images regarding the selected volume may be fused according to viewpoints and may be displayed.

In a medical imaging apparatus and a method of controlling the same according to one or more exemplary embodiments, an entire volume of the object restored in a three-dimensional manner may be partially segmented, and the segmented partial volume and entire volume may be reprojected from a plurality of viewpoints and fused and displayed on a three-dimensional display device. Accordingly, a contrast and a three-dimensional effect of an image may be improved.

Also, according to one or more exemplary embodiments, according to user's selection, reprojection images regarding the entire volume may be displayed, or reprojection images regarding the entire volume and at least one partial volume may be fused and displayed, or reprojection images regarding partial volumes may be displayed, or the reprojection images regarding partial volumes may be fused and displayed such that an image according to a diagnosis purpose may be provided.

Exemplary embodiments may also be implemented through computer-readable recording media having recorded thereon computer-executable instructions such as program modules that are executed by a computer. Computer-readable media may be any available media that can be accessed by a computer and include both volatile and nonvolatile media and both detachable and non-detachable media. Examples of the computer-readable media may include a read-only memory (ROM), a random-access memory (RAM), a compact disc (CD)-ROM, a magnetic tape, a floppy disk, an optical data storage device, etc. Furthermore, the computer-readable media may include computer storage media and communication media. The computer storage media include both volatile and nonvolatile and both detachable and non-detachable media implemented by any method or technique for storing information such as computer-readable instructions, data structures, program modules or other data. The communication media typically embody computer-readable instructions, data structures, program modules, other data of a modulated data signal such as a carrier wave, or other transmission mechanism, and they include any information transmission media.

Although a few exemplary embodiments have been shown and described, it would be appreciated by those skilled in the art that changes may be made in these exemplary embodiments without departing from the principles and spirit of the disclosure, the scope of which is defined in the claims and their equivalents.

What is claimed is:

1. A medical imaging apparatus comprising:
a scanner configured to obtain projection data of an object;
a three-dimensional restorer configured to restore a volume of the object based on the projection data;
a volume segmentor configured to generate at least one partial volume based on the volume of the object;
a reprojector configured to generate a plurality of reprojection images according to a plurality of virtual viewpoints by reprojecting at least one from among the volume and the at least one partial volume from the plurality of virtual viewpoints; and
an image fuser configured to generate a plurality of fusion images by fusing at least two of the plurality of reprojection images according to the plurality of virtual viewpoints.

2. The medical imaging apparatus of claim 1, wherein the scanner is configured to obtain the projection data from a plurality of viewpoints.

3. The medical imaging apparatus of claim 2, wherein the three-dimensional restorer comprises:
a cross-sectional image generator configured to generate a plurality of two-dimensional cross-sectional images of the object based on the projection data; and
a volume data generator configured to generate volume data of the object based on the plurality of two-dimensional cross-sectional images.

4. The medical imaging apparatus of claim 1, further comprising an inputter configured to receive selection of a part to be segmented from the volume,
wherein the volume segmentor is configured to segment the selected part from the volume.

5. The medical imaging apparatus of claim 4, wherein the inputter is configured to receive selection of the at least two of the plurality of reprojection images to be fused, and
the image fuser is configured to fuse the selected at least two of the plurality of reprojection images.

6. The medical imaging apparatus of claim 4, further comprising a display device configured to display the plurality of fusion images according to the plurality of virtual viewpoints in a three-dimensional manner.

7. The medical imaging apparatus of claim 6, wherein the inputter is configured to receive selection from among the plurality of reprojection images and the plurality of fusion images to be displayed on the display device in the three-dimensional manner, and
the display device is configured to display selected images in the three-dimensional manner.

8. The medical imaging apparatus of claim 6, wherein the display device comprises:
a display configured to display the plurality of fusion images according to the plurality of virtual viewpoints in the three-dimensional manner; and
a display controller configured to control the display.

9. The medical imaging apparatus of claim 8, wherein the display controller is configured to control the display to substantially simultaneously or alternately display the plurality of fusion images according to the plurality of virtual viewpoints.

10. The medical imaging apparatus of claim 9, wherein the display controller is configured to control to weave the plurality of fusion images according to the plurality of virtual viewpoints and control the display to display the weaved plurality of fusion images according to the plurality of virtual viewpoints.

11. The medical imaging apparatus of claim 1, wherein the scanner is configured to obtain the projection data of the object by performing at least one from among computed tomography (CT), positron emission tomography, tomosynthesis, and magnetic resonance imaging.

12. The medical imaging apparatus of claim 1, wherein the image fuser is configured to fuse the plurality of reprojection images by using at least one from among average, weighted average, edge preserving fusion, and maximum selection.

13. A method of controlling a medical imaging apparatus, the method comprising:
obtaining projection data of an object;
restoring a volume of the object based on the projection data;
generating at least one partial volume based on the volume of the object;
generating a plurality of reprojection images by reprojecting at least one from among the volume and the at least one partial volume from a plurality of virtual viewpoints; and
generating a plurality of fusion images by fusing at least two of the plurality of reprojection images according to the plurality of virtual viewpoints.

14. The method of claim 13, wherein the projection data is obtained from a plurality of viewpoints.

15. The method of claim 13, further comprising receiving selection of a part to be segmented from the volume,
wherein the generating the at least one partial volume comprises segmenting the selected part from the volume.

16. The method of claim 13, further comprising receiving selection of the at least two of the plurality of reprojection images to be fused,
wherein the generating the fusion images comprises fusing the selected at least two of the plurality of reprojection images according to the plurality of virtual viewpoints.

17. The method of claim 13, further comprising displaying the plurality of fusion images according to the plurality of virtual viewpoints in a three-dimensional manner.

18. The method of claim 17, further comprising:
receiving selection from among the plurality of reprojection images and the plurality of fusion images to be displayed in the three-dimensional manner; and
displaying selected images.

19. A method of controlling a medical imaging apparatus, the method comprising:
determining a first volume and a second volume of an object based on a plurality of scanned images of the object;
generating a plurality of first volume reprojection images by reprojecting the first volume of the object from a plurality of virtual viewpoints;
generating a plurality of second reprojection images by reprojecting the second volume of the object from the plurality of virtual viewpoints; and
providing a three dimensional image of the object based on the plurality of first reprojection images and the plurality of second reprojection images.

20. The method of claim 19, wherein the providing comprises providing the three dimensional image of the object based on fusion images generated by fusing the plurality of first reprojection images and the plurality of second reprojection images according to the plurality of virtual viewpoints.
